(19) United States
(12) Patent Application Publication
(10) Pub. No.: US 2012/0096005 A1
(43) Pub. Date: Apr. 19, 2012

(54) System and method for remote source data verification

(75) Inventor: Daniel O'Connor, Sandy, UT (US)

(73) Assignee: Innovo Commerce, LLC

(21) Appl. No.: 12/925,321

(22) Filed: Oct. 19, 2010

(51) Int. Cl. G06F 17/30

(52) U.S. Cl. 707/741; 707/E17.004

(57) ABSTRACT

A remote source data verification system. The inventive system includes a remote server running a novel source data verification software application adapted to electronically acquire images of source documents, index the images and store the images in a source database in a predetermined order based on the indexing, select an image from the source database, interface with a clinical database, and simultaneously display data from the clinical database alongside the selected image. In a preferred embodiment, the system uses an electronic pen or other real time data capture device that simultaneously creates physical source documents and corresponding electronic recordings. The recordings are automatically transmitted to the remote server and processed to generate images of the original source documents.

### BACKGROUND OF THE INVENTION

1. Field of the Invention

The present invention relates to data processing systems. More specifically, the present invention relates to systems and methods for verification of source data in clinical studies.

2. Description of the Related Art

Clinical studies are performed to evaluate the efficacy and safety of new drugs and other medical treatments. During a clinical trial, investigators (the physicians and other medical professionals conducting the study) recruit patients, administer treatments to the patients, and collect data on the patients' health over a predetermined period of time. The data is then sent to and analyzed by the study sponsor (typically a pharmaceutical company, academic institution, or government agency such as the National Institutes of Health).

The sponsors and investigators of a clinical trial must comply with all relevant regulations including the Code of US Federal Regulations enforced by the FDA and the ICH established Good Clinical Practices (GCP). One of the most important regulations involves ensuring data accuracy. Clinical studies are therefore generally required to perform source data verification (SDV), which is the process of verifying that the data being analyzed by the sponsors matches the original “source data” collected by the investigators.

Clinical source data includes all information in the original records of clinical findings, observations, or other activities in a clinical trial. Source data is contained in source documents (original records or certified copies), which are the documents where information is first recorded/captured by the investigators. These documents may include, for example, hospital records, clinical and office charts, laboratory notes, memoranda, subjects' diaries or evaluations, checklists, pharmacy dispensing records, recorded data from automated instruments, etc. The source documents are one of the “Essential Documents” that permit evaluation of the study and the quality of the data, and serve to demonstrate sponsor, investigator, and monitor compliance with GCP and regulatory requirements. Timely filing of source documents greatly assists in the management of a clinical trial, and they are of prime importance to the regulatory authorities in inspecting the trial and to the quality assurance auditor of the company in auditing the study.

In a typical study, the pervasive use of electronic data capture (EDC) systems has ensured that a great deal of data collected during the trial eventually ends up in digital format. However to this day a great number of studies are still captured on paper. Electronic data capture systems are usually web-based software systems for entering data collected at an investigator site (the location where an investigator is conducting the study, typically a physician's office or hospital) into an electronic case report form (CRF), transmitting the data to the sponsor, and storing the data in an electronic database.

The issue and challenge is that in nearly all cases, the original source data is captured by the investigator with pen and paper. An employee at the investigator site, such as a nurse or other office assistant, must then take the information that exists in the source documents (files, charts, memos, etc.) and transcribe that information into the EDC system provided by the sponsor. Because this process includes double entry of data, there is an increased probability of error that introduces more risk to the study. To mitigate this risk, the sponsor organization must expend great resources in the form of clinical site monitor salary and travel expenses to engage in the source data verification process. Source data verification is a requirement to maintain compliance with GCP. Some companies maintain internal policies that 100% of source data must be verified; other companies have incorporated risk based approaches where less critical information is only partly, randomly controlled via the source data verification process.

Source data verification is an evaluation of the conformity of the data presented in case report forms in the EDC system with the original source data. In this process, information reported by an investigator is compared with the original records to ensure that it is complete, accurate, and valid. The objective of source data verification is to ensure that the data collected is reliable, allowing reconstruction and evaluation of the study. Every item of data that appears in a case report form should be documented somewhere else to allow verification, audit, and reconstruction. Source data verification typically involves sending site monitors (clinical research associates who monitor the clinical studies to ensure compliance with the required regulations) to investigator sites to inspect the source documents and manually compare them to the corresponding information in the case report forms typically found in a clinical data capture repository.

The process of sending a site monitor to one site (and a typical clinical study can have hundreds of sites) to engage in source data verification can take weeks. The site monitor often encounters differences between the source data and the represented data in the electronic case report forms. The more mistakes captured later in the clinical process, the more costly they become in that they can slow down complex and costly clinical research. By some estimates for commercial sponsors, a one day delay in a clinical study can equate to a loss of $1 million. It is suspected that pharmaceutical sponsors may spend more than $50 million per year on the manual onsite source data verification processes. As the global pharmaceutical industry is changing due to a variety of economic, regulatory, and scientific drivers, companies around the world are seeking to increase quality (make less mistakes), drive down costs where possible, and boost productivity.

Hence, a need exists in the art for an improved method of source data verification for clinical studies that is faster and less expensive than conventional approaches.

### SUMMARY OF THE INVENTION

The need in the art is addressed by the remote source data verification system of the present invention. The inventive system includes a remote server running a novel source data verification software application adapted to electronically acquire images of source documents, index the images and store the images in a source database in a predetermined order based on the indexing, select an image from the source database, interface with a clinical database, and simultaneously display data from the clinical database alongside the selected image. In a preferred embodiment, the system uses an electronic pen or other real time data capture device that simultaneously creates physical source documents and corresponding electronic recordings. The recordings are automatically transmitted to the remote server and processed to generate images of the original source documents.

### BRIEF DESCRIPTION OF THE DRAWINGS

FIG. 1 is a simplified flow diagram of a conventional source data verification process.

FIG. 2 is a simplified flow diagram of a source data verification process in accordance with an illustrative embodiment of the present teachings.

FIG. 3 is a simplified block diagram of a remote source data verification system in accordance with an illustrative embodiment of the present invention.

FIG. 4 is a simplified flow diagram of a remote source data verification software application in accordance with an illustrative embodiment of the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

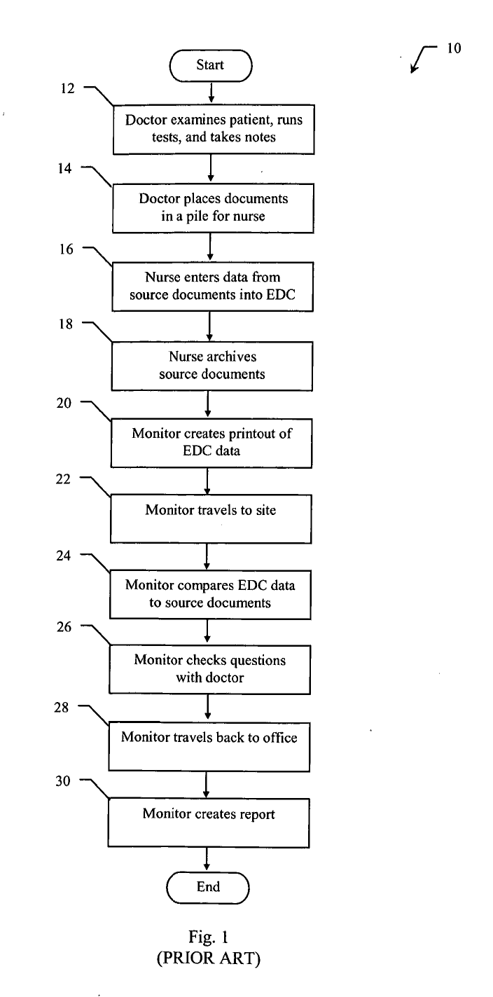

FIG. 1 is a simplified flow diagram of a conventional source data verification process 10. The process 10 begins with patient visits and the creation of source documents at the investigator site: at Step 12, the doctor examines the patient, administers treatments, runs tests, etc., and records measurements and notes (thereby creating the source documents).

At Step 14, after a patient visit, the doctor places the source documents in a pile for processing. The documents accumulate until, at Step 16, a nurse or other office assistant enters the data from the source documents into an electronic data capture (EDC) system or other case report form (CRF). At Step 18, the nurse then archives the source documents, filing them in a secure location.

After several weeks, a clinical research associate (CRA) or site monitor prepares for a trip to the investigator site. At Step 20, the monitor reviews the EDC data from the site and generates a printout of all the data that needs to be verified (including all of the data fields for every patient in the study at that site that has not been previously verified). This typically results in several pages of data.

At Step 22, the monitor travels to the investigator site and, at Step 24, manually compares the EDC data in the printouts with the original data in the archived source documents, noting any questions or discrepancies. This process may take several days to complete. At Step 26, the monitor checks any questions with the doctor. In the industry this can actually be many weeks after. If something is wrong and not detected then this can cause more errors of the same type in the meantime. Consequently, potential risk is introduced which could effect patient health or the viability of the study and or drug.

Finally, at Step 28, the monitor travels back to the clinical office and, at Step 30, typically after two to four weeks, creates and submits a report to the sponsor.

This process is repeated every four to six weeks for each site in the study (a typical study may include hundreds of sites). Conventional source data verification can therefore incur significant costs due to travel expenses, site monitor salaries, and delays in the research cycle.

The present invention addresses these issues by providing a novel remote source data verification system that electronically captures images of the clinical investigator source documents. The images are then organized, managed, and sorted by a novel software engine such that a remote monitor can compare the source document images with entries in the EDC system. This approach enables cost reduction by eliminating (or at least greatly reducing) the need for travel to sites and closing the time gap between a patient visit and data verification, enabling quick detection and response to errors.

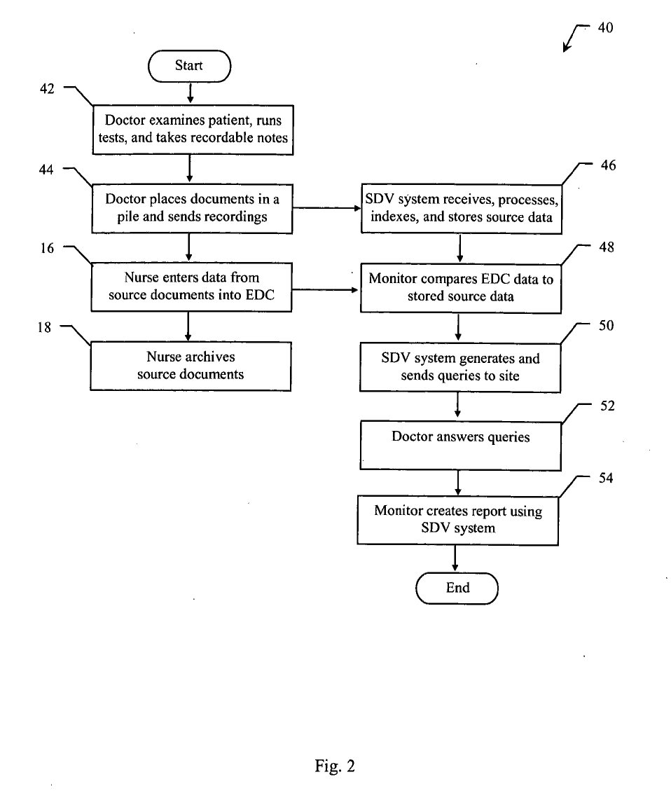

FIG. 2 is a simplified flow diagram of a source data verification process 40 in accordance with an illustrative embodiment of the present teachings. The process 40 begins with patient visits and the creation of source documents at the investigator site: at Step 42, the doctor examines the patient, administers treatments, runs tests, etc., and records measurements and notes. In a preferred embodiment, from the doctor's perspective, these steps are the same as the conventional approach except that the measurements and notes are written using an electronic pen or other real time capture technology. As described in greater detail below, the electronic pen writes with ink onto paper, so the doctor can take notes in his usual manner, but the pen also includes a sensor that electronically records the penstrokes. Thus, the doctor simultaneously creates both a physical source document and an electronic version of the source document. Other real time data capture devices, such as electronic pads, cameras, voice recorders, etc., may also be used to simultaneously create physical source documents and corresponding electronic recordings. The electronic recordings are automatically transmitted to a remote source data verification (SDV) server, where the recorded penstrokes are converted to images and stored in an image repository.

At Step 44, after a patient visit, the doctor places the physical source documents in a pile for processing as usual, and the electronic recordings are automatically transmitted to the remote SDV system. At Step 16, the nurse or other office assistant enters the data from the source documents into the EDC system as usual, and at Step 18, the nurse archives the source documents.

Meanwhile, at Step 46, the remote SDV system receives and processes the transmitted recordings, converting penstroke recordings into image files (source data images), and indexing and storing the source document images.

At Step 48, the site monitor accesses the remote SDV system from his office to simultaneously display the EDC data and the stored source document images. The site monitor compares the data and notes any questions or discrepancies electronically using the remote SDV system.

At Step 50, the remote SDV system automatically generates queries based on the monitor's notes and transmits the queries to the site (via, for example, email), and at Step 52, the doctor responds with answers to the queries.

Finally, at Step 54, the monitor inputs the doctor's answers into the remote SDV system and uses the SDV system to automatically generate a report.

Thus, the present invention eliminates the need for site monitors to travel to the investigator sites for source data verification (monitors may still need to occasionally travel to certain sites to investigate any recurring problems). Data verification is performed remotely by the monitor at the monitor's office. In a preferred embodiment, the remote SDV system includes web portal assess with secure, GCP compliant single sign on, allowing site monitors to perform source data verification from their home offices, central or division offices, or hotel rooms. The source data verification task could even be outsourced.

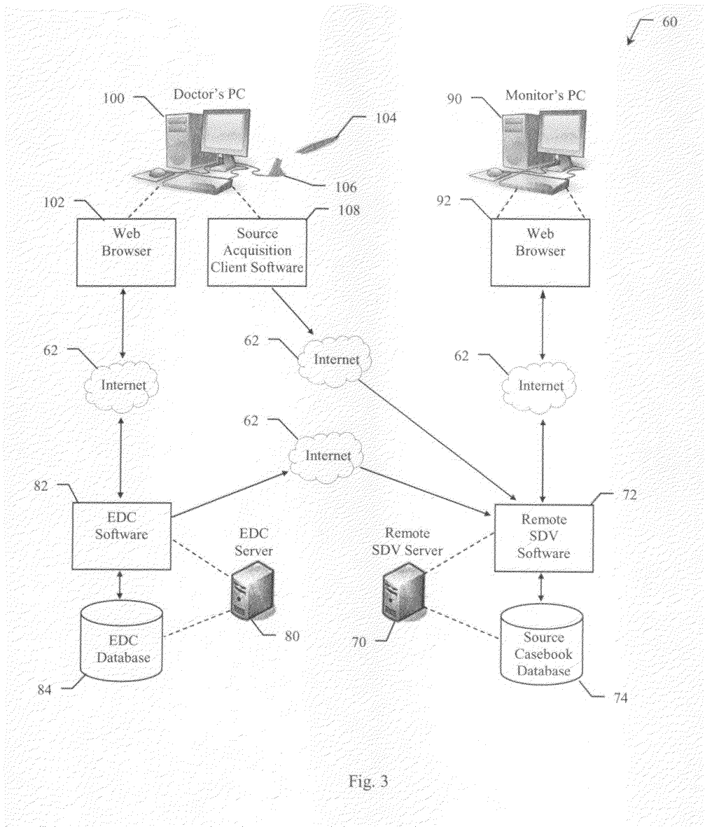

FIG. 3 is a simplified block diagram of a remote source data verification system 60 in accordance with an illustrative embodiment of the present invention. The overall system 60 includes a remote SDV server 70, the EDC server 80, the site monitor's computer 90, and a computer 100 at the investigator site.

The present invention provides a remote SDV software application 72 adapted to collect images of the source documents, intelligently index and organize the images, and store the image collection in a database 74. As shown in FIG. 3, the SDV application 72 is stored in and executed by a remote SDV server 70, which might be located at the remote SDV service provider.

During the actual data verification, the SDV application 72 interfaces with the EDC system 82 to simultaneously display data from EDC clinical database 84 alongside source document images. In the illustrative embodiment, the EDC system 82 is implemented as web-based software that is stored in and executed by an EDC server 80, which might be located at the EDC service provider. In the embodiment of FIG. 3, the EDC system 82 is external to the remote SDV system 72, and the SDV system 72 communicates with the EDC system 82 via a secure internet connection 62. Alternatively, the remote SDV application 72 may be integrated with the EDC system 82, such that both applications are running on a common computer.

In a preferred embodiment the remote SDV application 72 includes a web portal interface for allowing a site monitor to easily access the system 72 via a secure internet connection 62 using a web browser running on the monitor's computer 90. Alternatively, the remote SDV application 72 may be implemented as a stand-alone application running on the monitor's computer 90.

The investigator site is equipped with a computer 100 having a web browser 102 for interfacing with the EDC system 82. In a preferred embodiment, as described above, an electronic pen 104 is used by the doctor at the investigator site to simultaneously create physical and electronic source documents. The electronic pen 104 therefore includes both a traditional writing apparatus (e.g., ink and nib for writing on paper) and some kind of sensor for detecting and recording penstrokes to generate digital data. One such device that could be used for this application is the Anoto pen (described in U.S. Pat. No. 7,385,595), which includes an optical sensor for recording penstrokes on paper that includes a non-repeating pattern of dots. The dot pattern allows a processor to determine the location of the pen on the paper, and can also allow the processor to determine which page is being written on. Other types of electronic pens may also be used.

In the illustrative embodiment of FIG. 3, the electronic pen 104 is docked in a pen docking station 106, which is connected to a computer 100 (which may be the same computer that interfaces with the EDC system 82, or a different computer in the doctor's office). In this embodiment, the pen 104 includes an internal memory for storing the detected penstrokes. Upon docking in the docking station 106, the data in the pen memory is automatically downloaded to the computer 100.

In accordance with the present teachings, the computer 100 includes source acquisition client software 108, which is a small software program for receiving data from the digital pen 104 and automatically transmitting the data to the remote SDV system 72 via a secure internet connection 62. Optionally, the client software 108 may also include a simple user interface for allowing a user to send other types of data, such as other types of real time captured recordings, scanned image files, ECGs, lab tests, etc., from the computer 100 to the remote SDV system 72.

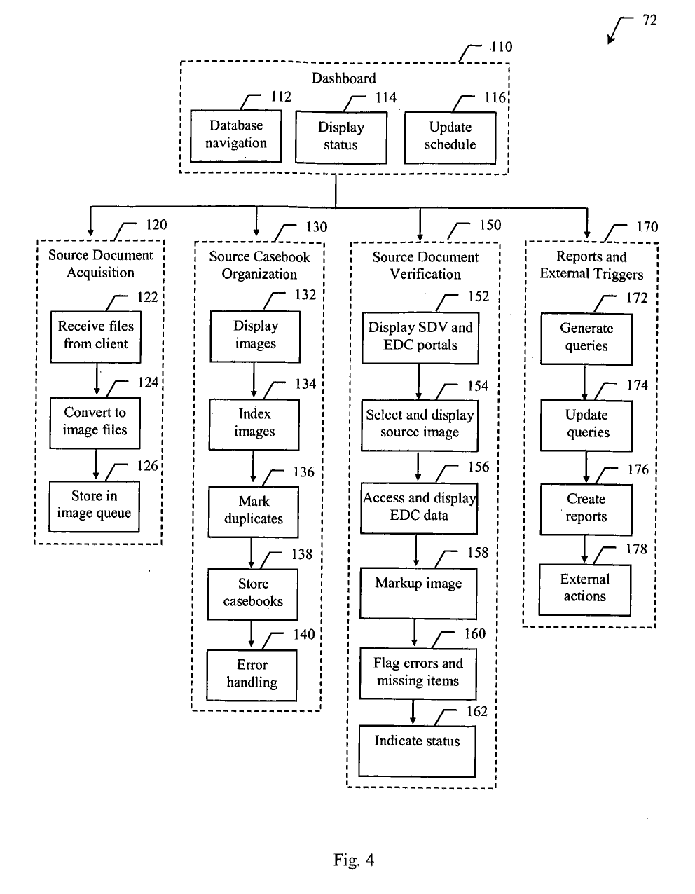

FIG. 4 is a simplified flow diagram of a remote SDV software application 72 in accordance with an illustrative embodiment of the present teachings. In the illustrative embodiment, the remote SDV system 72 includes a web portal for global, remote access. Appropriate security and controls are infused into the portal to ensure compliance with all laws and regulations.

In the illustrative embodiment, upon first accessing the portal, the system 72 displays a dashboard 110 showing site status. The dashboard includes a navigation tool 112 allowing the user to navigate through the studies and sites stored in the system database. Preferably, the dashboard displays the current status 114 of each site, including, for example, which source documents have been verified and which documents are awaiting verification, which images have been received and are awaiting classification, and which sites have open queries or have responded to a query.

Optionally, the system 72 may allow a user to input or update a study schedule 116. The study schedule includes the patient visiting schedule and indicates which source documents the system 72 should be receiving and when to expect those documents. In this case, the system dashboard 110 may also display which documents were expected but have not yet been received.

The system 72 includes a source document acquisition module 120 for automatically acquiring images of the source documents. At Step 122, the system 72 receives files from the investigator sites. Preferably, the system 72 is adapted to handle (store, display, manipulate) a variety of different image formats and sources, including scanned images and electronic pen outputs.

In a preferred embodiment, images of the original source data are acquired in a non-invasive manner (such that the doctor's regular routine is minimally affected) and transmitted as timely as possible to the remote SDV system. A non-invasive process is highly desirable in order to increase compliance, which means capturing all data, capturing data in the required manner, transmitting data at the earliest moment possible following a patient visit, and preferably facilitating easy data entry into the EDC system.

The image capturing device used is important in achieving compliance. Faxes, copiers, and scanners for instance are considered to be invasive. The invasiveness mostly becomes apparent when the task is usually delegated to the study nurse or other site personal. This can significantly decrease compliance and timeliness. The preferred embodiment therefore relies primarily on electronic pens or other real time data capture technology to capture the source documents.

Another dimension of image capture is the level of structure. There is no overall understanding in the industry from a legal, regulatory, or best practice focus, to which extent a sponsor can pre-structure certain source data such as notes taken during the visits. Some argue it is possible to have pre-prepared structured forms. Others agree on semi-structured, and others insist on non-structured forms. In the preferred embodiment, the SDV system 72 is adapted to handle all three approaches: pre-structured forms (forms having specific data fields to be filled out by the doctor), semi-structured forms (forms having specified data fields plus fields allowing the doctor to write free-form notes), and non-structured forms (free-form sheets where the doctor can write anything).

Each one of the options listed influences the choice of image capture device(s), the service level, and preparation time and costs versus processing time and costs. In general, structure requires more time to set up and is more costly upfront (device, programming) while unstructured is easier to set up with less sophisticated technology. However, the processing can be less automated and will thus be more expensive/resource intensive.

At Step 124, the received source documents are converted to a desired image format, if necessary. As described above, the electronic pens may output and transmit the recorded penstrokes. The system 72 may therefore include an algorithm for converting the penstrokes to an image.

Then, at Step 126, the source document images are store in an image queue, pending indexing and classification 130.

Next, an organization module 130 organizes the source document images into subject (patient) casebooks. The organizing may be performed automatically or manually by a user, or a combination of the two. For manual organization, the dashboard 110 indicates when images are in the image queue, awaiting classification. A user can then select the casebook organization function 130.

In casebook organization 130, the system 72 displays the document in the image queue and allows the user to select and display each document image 132. At Step 134, the user then indexes the image, identifying the study, site, subject (e.g., patient number), and visit, based on what is written on the document. The images may also include a classification based on the type of document, such as doctor's notes, lab results, ECG, etc.

Optionally, the system 72 may include an algorithm for automatically detecting some or all of the index keys. For example, the received document files may include information on the site that sent the files, allowing the system 72 to automatically determine the site. Furthermore, if the Anoto pen described above is used, the paper dot pattern may be used to identify the study and/or visit number. For example, a different dot pattern may be used on the forms for different visits. If the forms include a structured field for the patient identification number, the system 72 may include an optical character recognition program for automatically reading the patient number. If the system 72 encounters any problems automatically determining the index keys, the image is then stored in the image queue for manual indexing.

After the images are indexed, they are organized into casebooks. A casebook is created for each subject, and includes all of the documents indexed to that subject. The documents in the casebook are arranged in a specific sequence to enable simple and rapid navigation by the monitor during source data verification 140. For example, the documents may be arranged sequentially by visit. If a visit includes multiple documents (such as doctor's notes and lab results), the documents are arranged according to a predetermined hierarchy. Each site includes a collection of casebooks, and each study includes a collection of sites.

If an image is a duplicate of a document already in the casebook, the user can mark the image as a duplicate 136. Duplicates may occur if a file is mistakenly sent to the system 72 more than once. In accordance with regulations, duplicate documents are not deleted, but marked as a duplicate and stored in the casebook.

The casebooks of indexed source document images are then stored in the SDV database 138.

The system 72 also includes an error handling module 140. If at any point the user notices that a source document image is incorrectly indexed, the user can notify the error handling module 140, which moves the image from the SDV database back to the image queue to be reclassified.

Next, the source document verification module 150 enables the remote comparison of the source document images with data entered into the clinical database in order to verify the correctness and completeness of such data.

In an illustrative embodiment, when the user selects the verification task 150, the system 72 displays a split screen: a first part of the screen displays the SDV database navigation, while the second part of the screen displays the EDC portal 152.

At Step 154, the user navigates the SDV navigation, which lists the source document images in the SDV database, organized by study, site, and casebook in accordance with the previously determined indexing, and selects an image for verification. The selected image is then displayed on the SDV side of the screen.

At Step 156, the user accesses the external EDC system to display the corresponding EDC on the EDC side of the screen. In the illustrative embodiment, the clinical database is stored in an external, web-based EDC system (as shown in FIG. 3). The system 72 therefore includes an embedded web interface for accessing and displaying data from the clinical database. Alternatively, the system 72 may includes a plug-in for interfacing with a specific EDC system. Other interfacing schemes may also be used without departing from the scope of the present teachings.

The remote SDV system 72 therefore simultaneously displays the source document image and the corresponding EDC data, side by side. The user can then easily compare the EDC data with the source data that is written in the source document image.

The system 72 includes a markup tool 158 for visually marking areas of the source document image and associating marked areas with a field or fields in the EDC database. The markup tool 158 allows the user to select or highlight a part of the source document image (using, for example, a computer mouse or other input device). In response to the user's inputs, the system 72 visually marks the indicated area on the display (such as by highlighting the area with a particular color) and saves the location of the marked area as meta-data attached to the source document image. Note that the image itself is not actually altered; the information is saved separately as meta-data. After marking an area, the user can then add an annotation to the marked area, such as the corresponding data field from the EDC data or any other note. For example, the user might use the markup tool 158 to select the area on a document image where the doctor wrote the patient's blood pressure measurements and then add the annotation “blood pressure”. This method may be used to mark up all data fields in the image, or to only mark areas corresponding to data which is incorrect in the EDC database. In either case, the system 72 includes a tool 160 for flagging any discrepancies or missing data, or any other questions from the user. The flagged items can then be used to automatically generate queries for the investigators.

The system 72 also includes a tool 162 for allowing the user to express the status (whether or not an item has been verified) on a field, page, visit, and/or subject level.

In a preferred embodiment, if the remote SDV system 72 is integrated with the EDC system, the SDV module 72 can also include a tool for linking a selected source document image with a particular page or field of the EDC database.

The verification status indicators and flagged items entered by the user in the verification stage 150 can then be used to automatically generate reports and/or queries 170.

At Step 172, the system automatically generates queries based on the flagged items indicated by the user in the verification stage 150. In an illustrative embodiment, the queries for a particular site are listed in a web page that can be accessed by the site investigator, and the system 72 automatically notifies the site of any queries via email. The queries page includes form areas where the investigator can respond to the queries 174. The system 72 monitors if any queries are open and if the queries have been answered. Upon receiving a response, the site monitor can then update the information in the source document image database and/or the EDC database with the query responses.

When the user is done with the source data verification, the system 72 can automatically generate a monitoring report 176, listing, for example, all the fields, pages, subjects, and/or sites that have been verified, any data that is missing or incorrect, answers to any queries, etc. Depending on the findings, a trending is generated that determines what might need to be controlled at the site. Optionally, the system 72 may be adapted to automatically trigger external actions 178 on the basis of the internal data.

The present invention thus provides a novel method for source data verification that eliminates the need for site monitors to travel to investigator sites to inspect source documents. Instead, a novel software application is provided that electronically receives and processes images of the source documents, indexes and organizes the images into casebooks for easy navigation, and interfaces with an external EDC system to display clinical database entries next to a selected source document image, allowing a site monitor to easily compare the EDC entries with data written in the source document image. The inventive software also includes tools for marking up the source document images, annotating marked areas, flagging errors and missing items, and updating the verification status of the data. These meta-data can then be used to automatically populate queries and reports.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A source data verification system comprising:
first means for electronically acquiring images of source documents;
second means for indexing said images and storing said images in a source database in a predetermined order based on said indexing;
third means for selecting an image from said source database;
fourth means for interfacing with a clinical database; and
fifth means for simultaneously displaying data from said clinical database alongside said selected image.

2. The invention of claim 1 wherein said system further includes means for flagging errors and/or missing items in said selected image.

3. The invention of claim 2 wherein said system further includes means for automatically generating queries based on said flagged items.

4. The invention of claim 1 wherein said system further includes means for inputting a verification status for said selected image.

5. The invention of claim 4 wherein said system further includes means for automatically generating a report based on said status.

6. The invention of claim 1 wherein said system further includes means for marking areas of said selected image.

7. The invention of claim 6 wherein said system further includes means for adding annotations to said marked areas.

8. The invention of claim 1 wherein said second, third, fourth, and fifth means are software modules running on a remote server.

9. The invention of claim 8 wherein said first means includes a real time data capture device adapted to simultaneously create a physical source document and a corresponding electronic recording.

10. The invention of claim 9 wherein said first means further includes a client application running on a site computer adapted to automatically transmit said electronic recording to said remote server.

11. The invention of claim 10 wherein said first means further includes a software module running on said remote server for receiving said recording and converting said recording to an image.

12. The invention of claim 9 wherein said real time data capture device is an electronic pen.

13. A source data verification system comprising:
a remote server;
a site computer;
real time data capture device adapted to simultaneously create physical source documents and corresponding electronic recordings;
a client application running on said site computer adapted to automatically transmit said electronic recordings to said remote server; and
a software application running on said remote server, said application including:
a module for receiving said recordings and processing said recordings to generate images of said source documents;
a module for indexing said images and storing said images in a source database in a predetermined order based on said indexing;
a module for selecting an image from said source database;
a module for interfacing with a clinical database; and
a module for simultaneously displaying data from said clinical database alongside said selected image.

14. A method for source data verification including the steps of:
electronically acquiring images of source documents;
indexing said images and storing said indexed images in a source database in a predetermined order based on said indexing;
selecting an image from said source database;
interfacing with a clinical database; and
simultaneously displaying data from said clinical database alongside said selected image.
